(19) United States
(12) Patent Application Publication
(10) Pub. No.: US 2019/0073000 A1
(43) Pub. Date: Mar. 7, 2019

(54) ELECTRONIC DEVICE AND DOCKING STATION

(71) Applicants: INVENTEC (PUDONG) TECHNOLOGY CORPORATION, Shanghai City (CN); INVENTEC CORPORATION, Taipei City (TW)

(72) Inventor: Chieh-Hsiung LEE, Taipei City (TW)

(73) Assignees: INVENTEC (PUDONG) TECHNOLOGY CORPORATION, Shanghai City (CN); INVENTEC CORPORATION, Taipei City (TW)

(21) Appl. No.: 15/851,245

(22) Filed: Dec. 21, 2017

(30) Foreign Application Priority Data
Sep. 6, 2017 (CN) 201710795226.9

(51) Int. Cl. G06F 1/16; H01R 13/44; G06F 13/40; G06F 1/26

(52) U.S. Cl. CPC G06F 1/1632; H01R 13/44; G06F 1/1633; H01R 35/04; G06F 1/1601; G06F 1/266; G06F 13/4081

(57) ABSTRACT

A docking station has a casing, a first buckle structure, a second buckle structure, a buckling button, a transmission mechanism, a first communication connection port, a second communication connection port, a first USB connection port, and a USB controller chip. The casing at least has a bottom plate, a first side wall and a cover. The transmission mechanism is in the casing and connected to the buckling button, the first buckle structure and the second buckle structure. The first USB connection port is adapted for plugging into an external electronic device. The USB controller chip is respectively electrically coupled to the first USB connection port, the first communication connection port and the second communication connection port, and configured to implement a communication between the first USB connection port and the first communication connection port and a communication between the first USB connection port and the second communication connection port.

### CROSS-REFERENCE TO RELATED APPLICATIONS

This non-provisional application claims priority under 35 U.S.C. § 119(a) on Patent Application No(s). 201710795226.9 filed in China, on Sep. 6, 2017, the entire contents of which are hereby incorporated by reference.

### TECHNICAL FIELD

The invention is related to an electronic device and its docking station.

### BACKGROUND

An electronic device needs a variety of communication functionalities. However, one kind of communication functionality requires a corresponding connection port and occupies a certain space of the electronic device. It seriously limits the communication functionality of a mobile electronic device. In addition, a volume or a weight of a conventional electronic device cannot be reduced because of the requirement of the communication functionalities.

One dock interface of the electronic device is a connection port hub. However, the connection between the connection port hub and the electronic device is usually easy to be broken. Hence, how to provide an expansion interface with high stability in connection is a problem to be solve.

### SUMMARY

This invention is to provide an electronic device and its docking station so as to provide an expansion interface with stable connection for the electronic device.

In one embodiment, an electronic device has a processor, a platform controller hub (PCH), a first communication PHY circuit, a second communication PHY circuit, a universal serial bus (USB) connection port, and a USB controller chip. The PCH is electrically coupled to the processor. The first communication PHY circuit is electrically coupled to the PCH and configured to convert a piece of first information into a segment of first format signal or convert the segment of first format signal into the piece of first information. The second communication PHY circuit is electrically coupled to the PCH and configured to convert a piece of second information into a segment of second format signal or convert the segment of second format signal into the piece of second information. The USB connection port is adapted for plugging into an external electronic device. The USB controller chip is respectively electrically coupled to the USB connection port, the PCH, the first communication PHY circuit and the second communication PHY circuit and configured to implement a conversion between the segment of first format signal and a segment of first USB signal and to implement a conversion between the segment of second format signal and a segment of second USB signal so as to implement a communication between the PCH and the USB connection port, a communication between the first communication PHY circuit and the USB connection port, and a communication between the second communication PHY circuit and the USB connection port.

In one embodiment, a docking station has a casing, a first buckle structure, a second buckle structure, a buckling button, a transmission mechanism, a first communication connection port, a second communication connection port, a first USB connection port, and a USB controller chip. The casing at least has a bottom plate, a first side wall and a cover. The transmission mechanism is in the casing and connected to the buckling button, the first buckle structure and the second buckle structure. The first USB connection port is adapted for plugging into an external electronic device. The USB controller chip is in the casing and respectively electrically coupled to the first USB connection port, the first communication connection port and the second communication connection port, and configured to implement a communication between the first USB connection port and the first communication connection port and a communication between the first USB connection port and the second communication connection port.

As above, the stability of the connection between the docking station and the electronic device is improved by the buckle structure. Further, the amount and the types of the connection ports are both increased by the USB controller chips in the docking station and in the electronic device.

### BRIEF DESCRIPTION OF THE DRAWINGS

The present invention will become more fully understood from the detailed description given hereinbelow and the accompanying drawings which are given by way of illustration only and thus are not limitative of the present invention and wherein:

FIG. 1, which is a functional block diagram of an electronic device according to one embodiment of the present invention;

FIG. 2A is a schematic of structure of docking station according to one embodiment of the present invention;

FIG. 2B is a functional block diagram of the docking station according to one embodiment of the present invention;

FIG. 3A and FIG. 3B are schematics illustrating the connection way between the electronic device and the docking station;

FIG. 4 is a schematic of the structure of the docking station according to another embodiment of the present invention; and

FIG. 5 is a schematic of architecture of the combination of the electronic device and the docking station.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

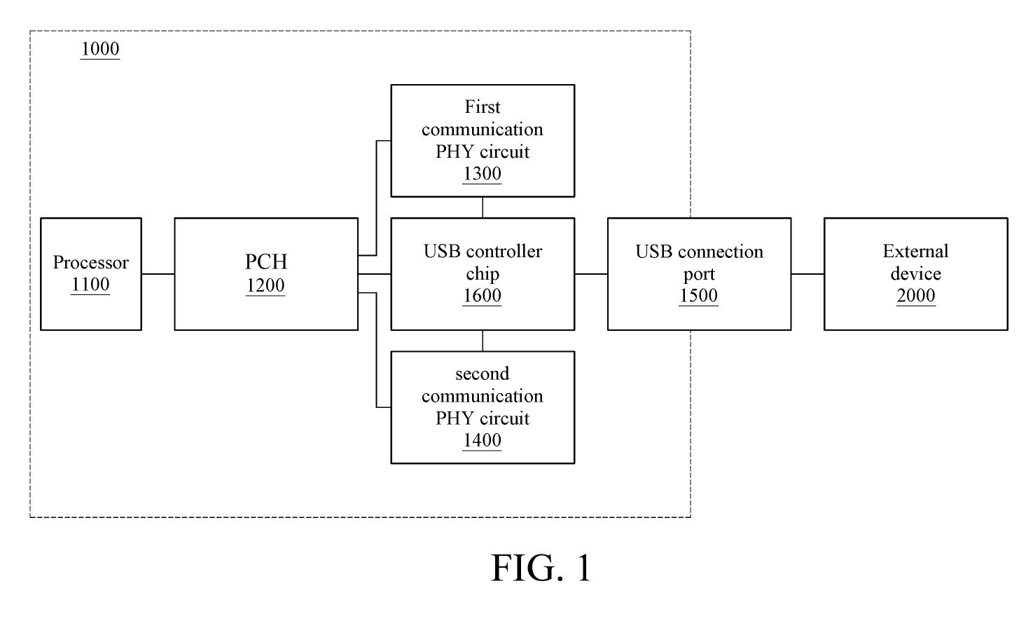

Please refer to FIG. 1, which is a functional block diagram of an electronic device according to one embodiment of the present invention. As shown in FIG. 1, the electronic device 1000 according to one embodiment of the present invention has a processor 1100, a platform controller hub (PCH) 1200, a first communication PHY circuit 1300, a second communication PHY circuit 1400, a universal serial bus (USB) connection port 1500, and a USB controller chip 1600.

In a first embodiment of the present invention, taking a laptop as an example of the electronic device 1000, the PCH 1200 is electrically coupled to the processor 1100. The first communication PHY circuit 1300 is, for example, a display chip electrically coupled to the PCH 1200 and configured to convert the received information into a display signal such as a DisplayPort format signal, a digital visual interface (DVI) format signal, a video graphics array (VGA) format signal, a high definition multimedia interface (HDMI) format signal or a mobile high-definition link (MHL) format signal. The second communication

PHY circuit 1400 is electrically coupled to the PCH 1200 and configured to convert the received information into a communication packet signal such as a peripheral component interconnect express (PCIe) signal or a conventional network packet signal. The USB connection port 1500 is adapted for plugging into an external device 2000 so as to implement the communication between the external device 2000 and the electronic device 1000.

The USB controller chip 1600 is, for example, Thunderbolt chip, Thunderbolt 2 chip, or Thunderbolt 3 chip. The USB controller chip 1600 is respectively electrically coupled to the USB connection port 1500, the PCH 1200, the first communication PHY circuit 1300 and the second communication PHY circuit 1400, and is configured to implement the conversion between the display signal and the USB signal and the conversion between the communication packet signal and the USB signal. Hence, the USB controller chip 1600 is capable of implementing the communication between the PCH 1200 and the USB connection port 1500, the communication between the first communication PHY circuit 1300 and the USB connection port 1500, and the communication between the second communication PHY circuit 1400 and the USB connection port 1500.

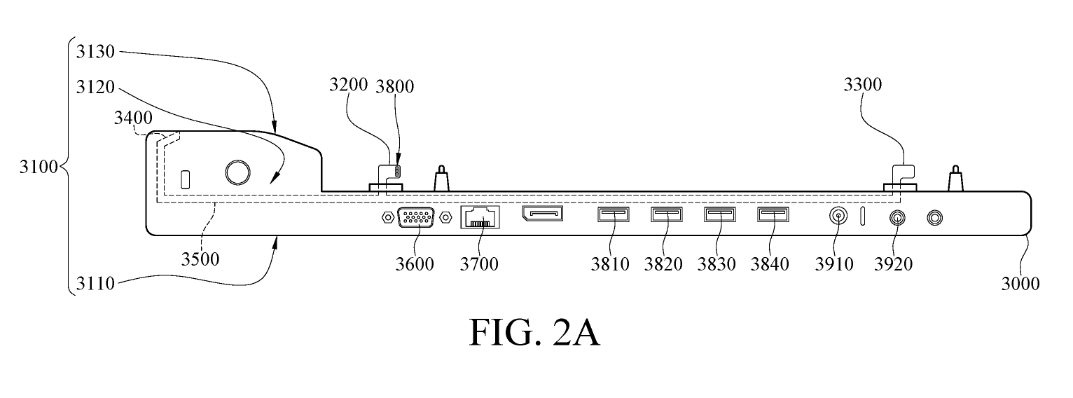

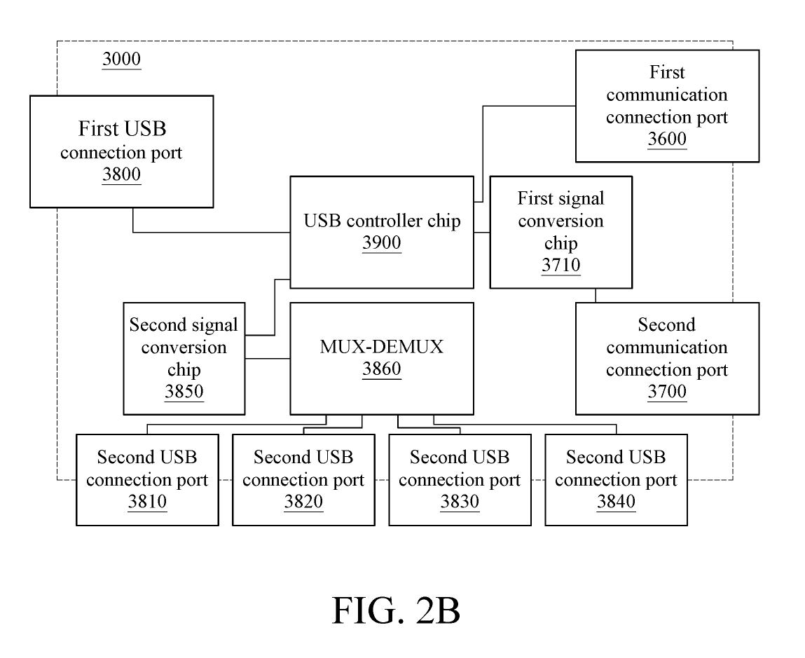

In addition, please refer to FIG. 2A and FIG. 2B for understanding the docking station corresponding to the electronic device 1000, wherein FIG. 2A is a schematic of structure of docking station according to one embodiment of the present invention, and FIG. 2B is a functional block diagram of the docking station according to one embodiment of the present invention. As shown in FIG. 2A, the docking station 3000 has a casing 3100. The casing 3100 at least has a bottom plate 3110, a first side wall 3120 and a cover 3130 so that an accommodation space is defined in the casing. A first buckle structure 3200 and a second buckle structure 3300 are both disposed on the cover 3130. A buckling button 3400 is disposed on the outer surface of the casing 3100. The buckling button 3400 is connected to the first buckle structure 3200 and the second buckle structure 3300 via the transmission mechanism 3500 in the casing 3100. A first communication connection port 3600, a second communication connection port 3700 and a first universal serial bus (USB) connection port 3800 are disposed on the first side wall 3130 of the docking station 3000. The first USB connection port 3800 is adapted for plugging into the aforementioned electronic device 1000. In one embodiment, the first USB connection port 3800, which is a male connection port, is on the first buckle structure 3200.

The casing 3100 of the docking station 3000 has the universal serial bus (USB) controller chip 3900 therein. The USB controller chip 3900 is respectively electrically coupled to the first USB connection port 3800, the first communication connection port 3600 and the second communication connection port 3700. The USB controller chip 3900 is configured to implement the communication between the first USB connection port 3800 and the first communication connection port 3600 and the communication between the first USB connection port 3800 and the second communication connection port 3600. The first communication connection port 3600 is, for example, a display device connection port, and its structure is such as a DisplayPort connection port, a DVI connection port, a VGA connection port, a HDMI connection port or a MHL connection port. In one embodiment, the docking station 3000 may have many first communication connection ports and each of the first communication connection ports has different structure. The second communication connection port 3700 is, for example, a network connection port and its structure is such as an RJ-45 port, an IEEE-1394 port, an RS-232 port, an RS-485 port or other adequate communication port, and the scope should not be limited in the present invention.

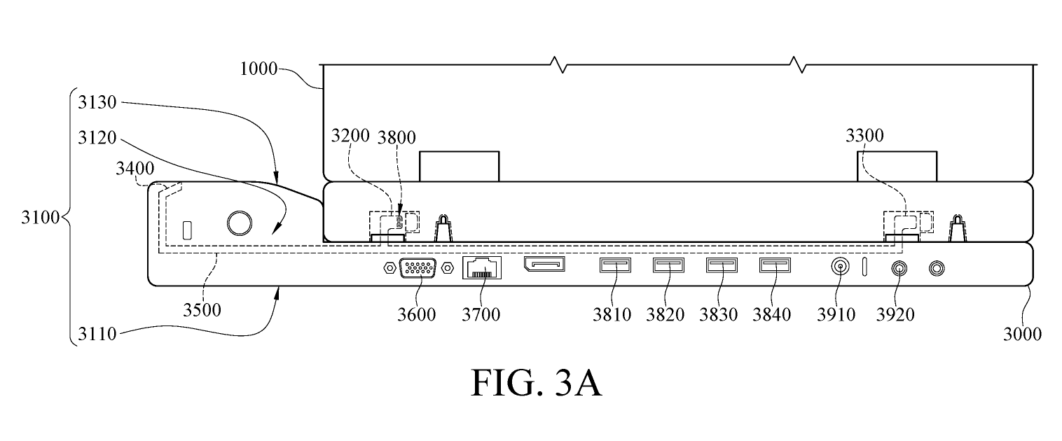

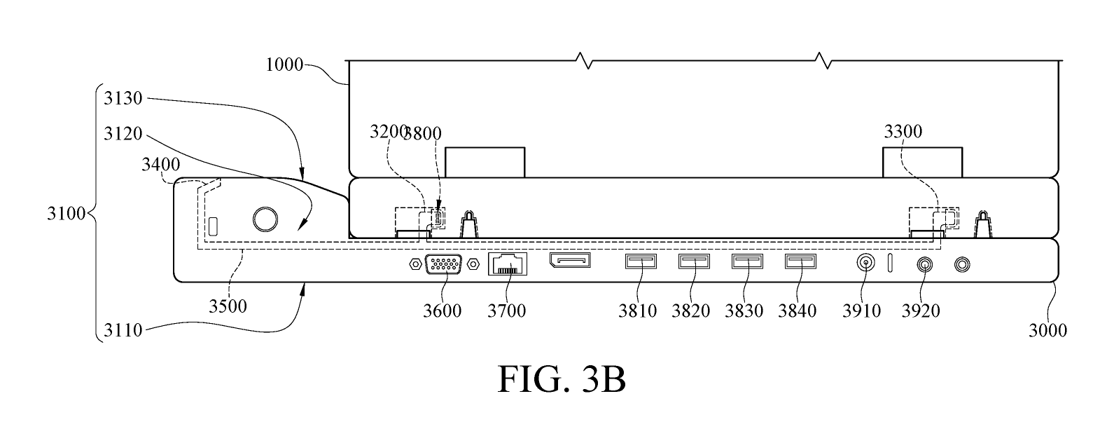

In the following paragraphs, some examples are taken to illustrate how the USB controller chip 1600 and the USB controller chip 3900 act. Please refer to FIG. 3A and FIG. 3B, wherein they are schematics illustrating the connection way between the electronic device and the docking station. In one embodiment, the user puts the electronic device 1000, a laptop, on the docking station 3000, as shown in FIG. 3A. Then the user pushes the buckling button 3400 from left to right so as to make the first buckle structure 3200 and the second buckle structure 3300 to move towards right to be buckled with the electronic device 1000. In this embodiment, the first USB connection port 3800, the male connection port, is on the first buckle structure 3200, and the electronic device 1000 has a USB connection port, a female connection port, disposed on the location corresponding to the first USB connection port 3800. Hence, when the first buckle structure 3200 is buckled with the electronic device 1000, the first USB connection port 3800 of the docking station 3000 is plugged into the USB connection port of the electronic device 1000 so as to implement the electrical coupling between the docking station 3000 and the electronic device 1000.

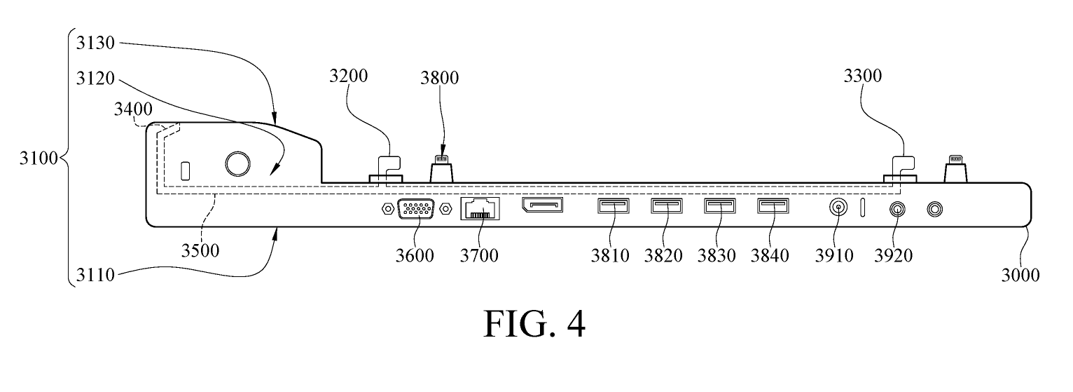

In another embodiment, please refer to FIG. 4, which is a schematic of the structure of the docking station according to another embodiment of the present invention. Compared with the embodiment in FIG. 2A, the first USB connection port 3800 is not on the first buckle structure 3200 but on the surface of the cover 3130 of the casing 3100 as shown in FIG. 4. The electronic device 1000 may have a corresponding USB connection port on the location corresponding to the first USB connection port 3800, so the electrical coupling between the docking station 3000 and the electronic device 1000 may be achieved when the electronic device 1000 is put onto the docking station 3000 in FIG. 4. In this embodiment, the first buckle structure 3200 and the second buckle structure 3300 function nothing but buckling the electronic device 1000 with the docking station 3000. In the aforementioned embodiment, the USB connection port 1500 of the electronic device 1000 and the first USB connection port 3800 of the docking station 3000 are, for example, USB Type-C connection ports. In the aforementioned embodiment, the buckling directions of both buckle structures are the same, from left to right. However, the buckling directions of the buckle structures may be different in another embodiment. For example, the buckling direction of the first buckle structure 3200 may be from left to right when the buckling direction of the second buckle structure 3300 is from right to left. One having ordinary skill in the art may adequately modify the buckling directions to meet the need.

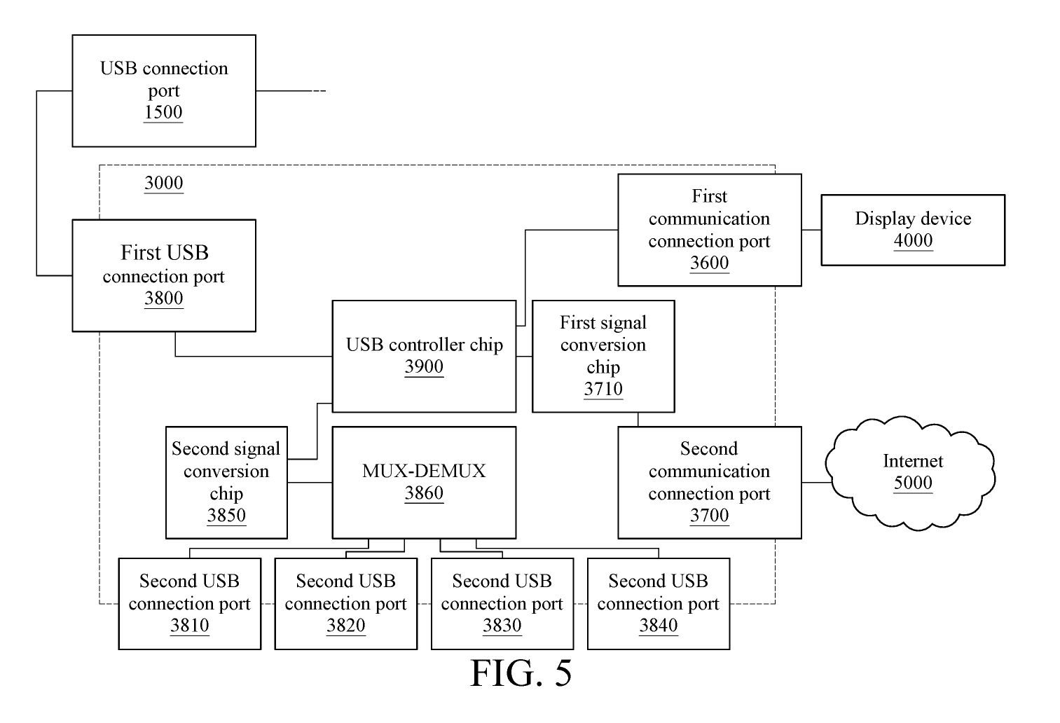

As to the system architecture of the combination of the electronic device 1000 and the docking station 3000 together, Please refer to FIG. 5, which is a schematic of architecture of the combination of the electronic device and the docking station. It can be seen in FIG. 5 that the first communication connection port 3600 of the docking station 3000 is electrically coupled to a display device 4000 and the second communication connection port 3700 is electrically coupled to the internet 5000.

In this condition, if the processor 1100 is to display an image on the screen of the electronic device, the processor 1100 sends the information of the image via the PCH 1200 to the first communication PHY circuit 1300, a GPU for example. The first communication PHY circuit 1300 converts the information to the DisplayPort format signal or HDMI format signal so as to let the screen show the correct image. If the user now operates the electronic device 1000 to send the image to the display device 4000, the PCH make the first communication PHY circuit 1300 to send the DisplayPort format signal to the USB controller chip 1600 of the electronic device 1000, and the USB controller chip 1600 converts the DisplayPort format signal to the USB signal and sends the USB signal via the USB connection port 1500 of the electronic device 1000 to the first USB connection port 3800 of the docking station 3000. The USB controller chip 3900 of the docking station 3000 converts the USB signal to the DisplayPort format signal and sends it to the first communication connection port 3600 so that the display device 4000 displays the image.

In one embodiment, the docking station 3000 further has a first signal conversion chip 3710 respectively electrically coupled to the USB controller chip 3900 and the second communication connection port 3700. The first signal conversion chip 3710 is, for example, a network interface controller (NIC) capable of converting the peripheral component interconnect express signal into the network packet. Similarly, when the processor 1100 of the electronic device 1000 needs to communicate with the internet 5000, the processor 1100 sends the information via the PCH1200 to the second communication PHY circuit 1400 so that the second communication PHY circuit 1400 sends the received information to the USB controller chip 1600 of the electronic device 1000 with PCIe signal. The USB controller chip 1600 converts the received PCIe signal to the USB signal and sends the USB signal to the USB connection port 1500. The USB signal is sent to the USB controller chip 3900 of the docking station 3000 via the first USB connection port 3800 of the docking station 3000. The USB controller chip 3900 converts the received USB signal to PCIe signal and sends the PCIe signal to the first signal conversion chip 3710. The, the first signal conversion chip 3710 converts the PCIe signal to network packet and sends the network packet to the internet 5000 via the second communication connection port 3700. One having ordinary skill in the art shall understand that the signal transmission and signal conversion can be reversed so that the signal may be sent from the internet 5000 to the processor 1100 of the electronic 1000.

In another embodiment, the docking station 3000 further has many second USB connection ports 3810˜3840, a second signal conversion chip 3850 and a MUX-DEMUX 3860. The second signal conversion chip 3850 is electrically coupled to the USB controller chip 3900 and configured to convert the PCIe signal to the USB signal again. The USB signal transmitted between the electronic device 1000 and the docking station 3000 is, for example, a signal meeting the USB Type-C format while the USB signal obtained by the second signal conversion chip 3850 is USB 1.0/2.0/3.0 format signal, in one embodiment.

The MUX-DEMUX 3860 is respectively electrically coupled to the second signal conversion chip 3850 and a plurality of second USB connection ports 3810˜3840. Specifically, the MUX-DEMUX 3860 allows one among the plurality of second USB connection ports 3810˜3840 to electrically couple to the second signal conversion chip 3850 with time divisional technique.

In the aforementioned embodiments, to ensure that the signal transmission between the processor 1100 of the electronic device 1000 and the connection ports of the docking station 3000 is correct, the USB controller chip 1600 and the USB controller chip 3900 may insert an indication flag into a specified field of one packet when a conventional signal is converted into USB signal. When the USB signal is to be converted to the conventional signal, the signal format may be determined based on the indication flag. In one embodiment, if a DisplayPort format signal is converted into USB signal, the packet of the USB signal has the indication flag x01. Hence, when the USB controller chip 3900 receives the USB signal packet, the USB controller 3900, based on the indication flag x01, converts this USB signal packet into the DisplayPort format signal or other adequate display signal and sends it to the first communication connection port 3700.

In another embodiment, please refer back to FIG. 2A. The docking station 3000 may further have a power socket 3910 and an audio socket 3920. The user may plug a transformer into the power socket 3910 so as to provide power to the docking station 3000 with main electricity. Similarly, the electronic device 1000 may sends audio signal via the docking station 3000 to the audio socket 3920.

As above, the stability of the connection between the docking station and the electronic device is improved by the buckle structure. Further, the amount and the types of the connection ports are both increased by the USB controller chips in the docking station and in the electronic device.

What is claimed is:

1. An electronic device, comprising:
a processor;
a platform controller hub (PCH) electrically coupled to the processor;
a first communication PHY circuit electrically coupled to the PCH and configured to convert a piece of first information into a segment of first format signal or convert the segment of first format signal into the piece of first information;
a second communication PHY circuit electrically coupled to the PCH and configured to convert a piece of second information into a segment of second format signal or convert the segment of second format signal into the piece of second information;
a universal serial bus (USB) connection port adapted for plugging into an external electronic device; and
a USB controller chip respectively electrically coupled to the USB connection port, the PCH, the first communication PHY circuit and the second communication PHY circuit and configured to implement a conversion between the segment of first format signal and a segment of first USB signal and to implement a conversion between the segment of second format signal and a segment of second USB signal so as to implement a communication between the PCH and the USB connection port, a communication between the first communication PHY circuit and the USB connection port, and a communication between the second communication PHY circuit and the USB connection port.

2. The electronic device in claim 1, wherein the segment of first format signal is selected from a group consisting of a DisplayPort format signal, a digital visual interface (DVI) format signal, a video graphics array (VGA) format signal, a high definition multimedia interface (HDMI) format signal and a mobile high-definition link (MHL) format signal.

3. The electronic device in claim 1, wherein the segment of second format signal is a peripheral component interconnect express (PCIe) signal.

4. The electronic device in claim 1, wherein the USB connection port is a USB Type-C female connection port.

5. The electronic device in claim 1, wherein the USB controller chip is a Thunderbolt controller chip.

6. A docking station, comprising:
a casing at least having a bottom plate, a first side wall and a cover;
a first buckle structure on the cover;
a second buckle structure on the cover;
a buckling button on a outer surface of the casing;
a transmission mechanism in the casing connected to the buckling button, the first buckle structure and the second buckle structure;
a first communication connection port on the casing;
a second communication connection port on the casing;
a first universal serial bus (USB) connection port adapted for plugging into an external electronic device; and
a universal serial bus controller chip in the casing and respectively electrically coupled to the first USB connection port, the first communication connection port and the second communication connection port, and configured to implement a communication between the first USB connection port and the first communication connection port and a communication between the first USB connection port and the second communication connection port. The docking station in claim 6, wherein the USB connection port is a USB Type-C male connection port.

8. The docking station in claim 6, wherein the USB controller chip is a Thunderbolt controller chip.

9. The docking station in claim 6, wherein the first USB connection port is on the first buckle structure.

10. The docking station in claim 6, wherein a buckling direction of the first buckle structure is different from a buckling direction of the second buckle structure.
